(19) United States
(12) Patent Application Publication
(10) Pub. No.: US 2002/0194873 A1
(43) Pub. Date: Dec. 26, 2002

(54) Method of reducing volatilization from and increasing homogeneity in glass

(75) Inventor: John Albert Hockman, Bath, PA (US)

Correspondence Address: Marvin J. Powell, 1 Highland Avenue, Bethlehem, PA, 18017, US

(73) Assignee: Specialty Minerals (Michigan) Inc.

(21) Appl. No.: 09/878,658

(22) Filed: Jun. 11, 2001

(51) Int. Cl. C03B 5/225

(52) U.S. Cl. 65/134.1

(57) ABSTRACT

A method is provided for the production of glass with reduced volatilization of components. Such method allows the reduction of emitted metals and other volatiles in the production of glass. The method encompasses the use of a calcium magnesium silicate in the production glass composition.

### FIELD OF THE INVENTION

The present invention relates to glass production. In particular it relates to the composition of the glass batch refined during the glass production operations.

### BACKGROUND

Glass production typically occurs through the production of a glass batch which is melted and refined before the final glass production operations are performed. Refining is the heating step which, among other purposes, results in a mixed composition of reacted components and emission of gases of volatilized materials. Among the components admixed to form the glass batch composition are melting or refining aids which have value in the mixing and reaction operation in forming the glass composition, although may not add value to the glass composition itself. For example, boron is used as a melting aid in many operations. Another material is lead, which is a component of many crystal type glasses. Because of the high temperatures used in the melting and refining operations much of these components can be lost due to volatilization. Such loss represent requires use of an excess amount and results in unwanted emissions and costs. Accordingly, there is a need for a method of producing glass batches with reduced volatilization.

### SUMMARY

The present invention has an objective of providing a method for the production of a glass composition with reduced loss of volatiles. Another objective is to provide a glass composition with increased homogeneity and purity. These and other objectives are achieved by a method for preparing a volatile-containing glass composition comprising forming a batch of glass-forming components by mixing a volatile component source, a silicate component, and other glass-forming components. The batch of glass-forming components is melted and refined to obtain a glass composition. The refining produces a glass composition with greater homogeneity and purity. Also, less volatiles are evolved during glass operations than a glass composition having equivalent composition produced without using the silicate component.

### DESCRIPTION OF PREFERRED EMBODIMENTS

One embodiment of the present invention is a method for preparing a glass composition in which a batch of glass-forming components is formed by admixing a volatile component source, a silicate compound, and other glass-forming components. This glass forming composition is then melted and refined in a furnace. The resultant glass composition has a reduced variability of oxides distribution measured at the feed end of said furnace or a reduced loss of the volatile component than a glass composition having an equivalent composition produced without using the silicate compound.

The volatile is preferably selected from the group consisting of boron and heavy metals. Heavy metals include, for example, lead, selenium, and cobalt. Other heavy metals can be used, depending upon the glass maker's particular formulation.

The silicate compound is a silicate compound of the formula KᵤNaᵥAl_{w}CaₓMg_{y}SiO_{z}, wherein K is potassium, Na is sodium, Al is aluminum, Ca is calcium, Mg is magnesium, Si is silica, and O is oxygen and u, v and w, independently range from about 0 to about 0.5; x and y independently range from about 0.1 to about 0.6; and z is a value which balances the empirical formula. The silicate compound can be derived from natural resources or conveniently synthesized using the methods of U.S. Pat. No. 6,211,103 B1. In one embodiment, the values of u, v, and w respectively are about 0 and the values of x and y are preferably about 0.5.

The other glass-forming components are determined by the proprietary formula of the glass manufacturer. Typically, sand, dolomite, caustic and other material providing inorganic compound for a particular application are provided.

The melting and refining of the batch of glass-forming components is performed in a glass production furnace using typical glass production methods and conditions. No particular method of addition, mixing or order thereof is required. The resultant melt can be processed in the furnace to produce a glass composition. An advantage of the present invention is that typical operating temperatures can be reduced by as much as 50 degrees Centigrade or more. Those skilled in the glass-making art can readily decide the balancing of temperature reductions against glass pull rates from the furnace afforded by this advantage, keeping in mind the favorable reduction of volatiles also afforded herein. Another advantage is the faster attainment of the glass melt's cross-section profile homogeneity due to reductions in viscosities, increase in heat transfers and the like.

When the method of the present invention is used, the produced glass composition has a reduced variability of oxides distribution measured at the feed end of said furnace and/or a reduced loss of said volatile component than a glass composition having an equivalent composition produced without using said silicate compound. The variability of oxide distribution obtained is favorably reduced using the present invention by at least about ten percent, more preferably fifteen percent.

The volatile mass loss is favorably reduced by at least about five percent by mass, more preferably ten percent by mass. In the embodiment in which h boron is the volatile, the reduction of the loss of boron through volatilization is at least about ten percent by weight.

In another preferred embodiment, the above method is modified by the additional mixing of a feldspathic component. Such feldspathic material can be one of any of the numerous natural or synthetic forms of feldspar or feldspar-type material. Such feldspathic material is an aluminosilicate with barium, calcium, potassium, or sodium component. Preferably, the feldspathic material is a potassium aluminosilicate having the formula KAlSi₃O₈ with little sodium values.

The following examples are meant to illustrate the present invention but are not intended to be a limitation thereon.

### EXAMPLE 1

A glass-forming batch is produced by the combining of Synsil® silicates, sand, and other proprietary compounds to produce a glass batch having typical oxide values. The Synsil® silicate is produced in accordance with the method of U.S. Pat. No. 6,211,103 B1 and obtained from Synsil Products Inc., has the following empirical values:

| Oxide Component | Mass Percent |
|---|---|
| CaO | 24.5 |
| MgO | 17.8 |
| SiO₂ | 53.5 |
| Al₂O₃ | 3.4 |
| Fe₂O₃ | 0.12 |
| Na₂O | 0.40 |

The glass batch is composed of the following composition:

| Component | Mass Percent |
|---|---|
| Synsil ® silicate | 15 |
| Volatile component | 0.5 |
| Other components | 84.5 |

A comparative batch is formed with the equivalent final glass oxides by replacing the Synsil® silicate with the appropriate amount of dolomite. The temperature of the log 3 viscosity of the inventive glass is at least about 20 degrees Centigrade or less than that for the comparative sample. Such lower viscosity results in better homogeneity and reduced variability of oxides.

What is claimed is:

1. A method for preparing a glass composition, said method comprising forming a batch of glass-forming components by admixing a volatile component source containing a volatile selected from the group consisting of boron and heavy metals; a silicate compound of the formula KᵤNaᵥAl_{w}CaₓMg_{y}SiO_{z}, wherein K is potassium, Na is sodium, Al is aluminum, Ca is calcium, Mg is magnesium, Si is silica, and 0 is oxygen and u, v and w, independently range from about 0 to about 0.5; x and y independently range from about 0.1 to about 0.6;
and other glass-forming components; melting and refining the batch of glass-forming components in a furnace the resultant melt to obtain a glass composition; wherein said glass composition has a reduced variability of oxides distribution measured at the feed end of said furnace or a reduced loss of said volatile component than a glass composition having an equivalent composition produced without using said silicate compound.

2. The method of claim 1 further comprising the admixing of a feldspathic component.

3. The method of claim 1 wherein u, v, and w respectively are about 0.

4. The method of claim 1 wherein the volatile is a lead or selenium compound.

5. The method of claim 1 wherein the volatile is boron.

6. The method of claim 5 wherein the volatilized boron is reduced by at least about ten percent by weight.
